(19) United States
(12) Patent Application Publication
(10) Pub. No.: US 2015/0312535 A1
(43) Pub. Date: Oct. 29, 2015

(54) SELF-ROUSING SURVEILLANCE SYSTEM, METHOD AND COMPUTER PROGRAM PRODUCT

(71) Applicant: International Business Machines Corporation, Armonk, NY (US)

(72) Inventors: Sergio Borger, Demarest, NJ (US); Carlos Cardonha, Sao Paulo (BR); Ademir Silva, Sao Paulo (BR); Fernando Koch, Campinas (BR)

(73) Assignee: International Business Machines Corporation, Armonk, NY (US)

(21) Appl. No.: 14/259,266

(22) Filed: Apr. 23, 2014

(51) Int. Cl. H04N 7/18; H04N 5/77

(52) U.S. Cl. CPC H04N 7/188; H04N 7/181; H04N 5/77

(57) ABSTRACT

A self-rousing surveillance system, method and computer program product for monitoring activity across a geographical location. Surveillance sensors are distributed about a geographical location and normally in a low surveillance state. A sensor controller controls data collection by each surveillance sensors. An event monitor receives reports indicating events at local areas within the geographical location. The event monitor identifies local areas with each report. The sensor controller places surveillance sensors identified with the respective local area in a heightened surveillance state in response to received reports

### BACKGROUND OF THE INVENTION

1. Field of the Invention

The present invention is related to managing surveillance systems and more particularly to managing surveillance of a geographical area to minimize resource consumption without overwhelming security personnel.

2. Background Description

Surveillance systems have become ubiquitous in modern society. London, for example, is blanketed with surveillance cameras. A typical surveillance system includes multiple sensors distributed about an area monitoring area activity. Typical surveillance sensors include still and video cameras, audio sensors or receivers, motion sensors, and heat sensor (e.g., infrared (IR) detectors), all of which may be relatively cheap. Cheap high definition (HD) cameras, for example, can be distributed to cover a surveillance area, capturing both high resolution images and video for contemporaneously monitoring activity. Privacy concerns aside, what these system capture is limited only by the capability of security personnel to simultaneously monitor multiple views and available storage capacity.

After the Boston Marathon of 2013, for example, authorities identified suspects from cached video that was collected during the marathon from area surveillance cameras. From those images people familiar with the suspects eventually identified them by name, which allowed the manhunt to begin, culminating in their arrest. However, this was all several days post marathon and after the subsequent related events. If authorities had been alerted to suspicious activity during the marathon, the whole incident might have been avoided. If better images or video were available, the perpetrators might have been identified earlier, and the subsequent loss of life might have been averted. However, there were so many cameras in the vicinity of the event, that it would′ve taken an army of security guards to watch them all in real time, and the voluminous data from real time video would′ve been too large to collect, much less review in a timely manner post event.

Thus, there is a need for surveillance systems that are capable of collecting data from an area blanketed with surveillance sensors, and more particularly, for surveillance systems that are capable of collecting data from an area blanketed with surveillance sensors without overwhelming security personnel and with sufficient compression to cache pertinent data.

### SUMMARY OF THE INVENTION

A feature of the invention is a surveillance system that provides surveillance when and where necessary;

Another feature of the invention is a surveillance system that comprehensively monitors a geographic area with a sufficient number of sensors without overwhelming security personnel and resources;

Yet another feature of the invention is a surveillance system that comprehensively monitors a geographic area and provides targeted surveillance for local areas within the geographic area when necessary;

Still another feature of the invention is a surveillance system that comprehensively monitors a geographic area with a sufficient number of sensors without overwhelming security personnel and resources, providing targeted surveillance for local areas within the geographic area when and as necessary.

The present invention relates to a self-rousing surveillance system, method and computer program product for monitoring activity across a geographical location. Surveillance sensors are distributed about a geographical location and normally in a low surveillance state. A sensor controller controls data collection by each surveillance sensors. An event monitor receives reports indicating events at local areas within the geographical location. The event monitor identifies local areas with each report. The sensor controller places surveillance sensors identified with the respective local area in a heightened surveillance state in response to received reports.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a self-rousing surveillance system with local surveillance sensors selectively monitoring activity in an area according to a preferred embodiment of the present invention;

FIG. 2 shows an example of selectively monitoring activity in an area;

FIG. 3 shows an alternate example of monitoring activity in an area.

### DESCRIPTION OF PREFERRED EMBODIMENTS

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

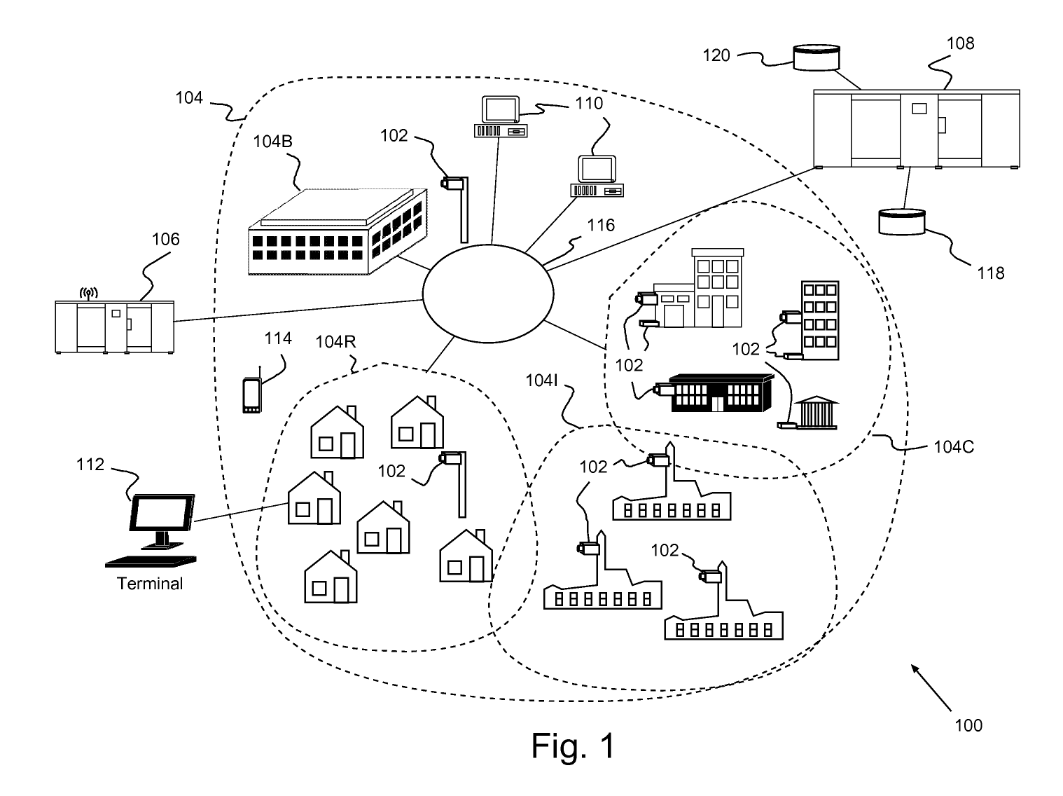

FIG. 1 shows an example of a self-rousing surveillance system 100 with local surveillance sensors 102 selectively monitoring activity in an area 104 according to a preferred embodiment of the present invention. A sensor controller, e.g., computer 106, controls local surveillance sensors 102, e.g., adjusting directional placement, sensor resolution, detail and input quality. An event monitor, computer 108 in this example, receives contemporaneous event reports, e.g., from area kiosks 110, residential computers 112 and other available input, e.g., portable devices 114, over network 116. Optionally, the system 100 may include a classifier 118 in software or hardware, that classifies each report by report type according to previously identified types; and, a confidence generator 120 also in software or hardware, that assigns a confidence figure of merit to each report.

Local sensors 102 may include widely deployed surveillance cameras, audio sensors or receivers, motion sensors, and heat sensor, e.g., infrared (IR) detectors. The sensors 102 may be distributed in the area 104 in residential neighborhoods 104R, commercial areas 104C, industrial areas 1041 and even in individual buildings 104B. The sensor controller 106 adjusts local surveillance sensors 102 based on a perceived need for surveillance extracted from incoming reports to selectively focus and enhance surveillance. The sensor controller 106 can enhance surveillance, for example, by refocussing and/or adjusting directional placement, activating additional surveillance sensors 102 by altering focal length, or by augmenting capturing rate to increase resolution, detail and sensor input quality. Further, determining whether to adjust can be based simply on report frequency, report contents or, in response to user submissions from a citizen sensing platform stations, e.g., from kiosks 110 positioned at various locations in a city.

The preferred event monitor 108 can assign priority to sensor controller 106 for sensor interrogation, for example, setting surveillance video processing priority from based on citizen sensing reports and/or report contents. The event monitor 108 computer may be a remote server, for example, receiving reports related to area events, e.g., reports on fires, criminal activity, accidents, infrastructure issues, urban events, service problems, weather related events, transportation issues, and natural events. With each received report, the event monitor 108 logs report activity and monitors related information to identify any local need for heightened security, and based on report type, routes the reports to corresponding processing locations, e.g., a fire station, a police station, maintenance services, a central operation center, or elsewhere.

The event monitor 108 also may identify potential needs for enhanced surveillance from the reports. Increasingly frequent reports arriving for a specific locale, for example, may indicate that activity is increasing and may merit enhanced security and attention to a specific locale. Further, report credibility may be determined from report frequency and origination, by the number of such reports, by the clustering of similar reports, by the grouping of geographically related reports, and/or by a peer ranking of reports. Reports from area kiosks 110 and residential computers 112 may be treated as credible by default. Reports may be made from any suitable computer, either through a special purpose application or using a general purpose capability, e.g., a web page for receiving reports. Similarly, portable devices 114, such as smartphones and/or tablets may include report apps for reporting to the event monitor 108.

Thus, event monitor 108 may monitor, for example, the number of reports, the location of the reporter, and how the classifier 118 classifies the reported event. Further, the confidence generator 120 may review reporter annotations for the event, e.g., through voice capture, text capture and image capture techniques. For example, to extract confidence information the confidence generator 120 may interrogate an image or video of the event, determine sentiment from analysis of text and voice capture, or context from geographically related events. In some instances peers may rank reports, and in other instances, the confidence generator 120 may correlate reports with events in a report database.

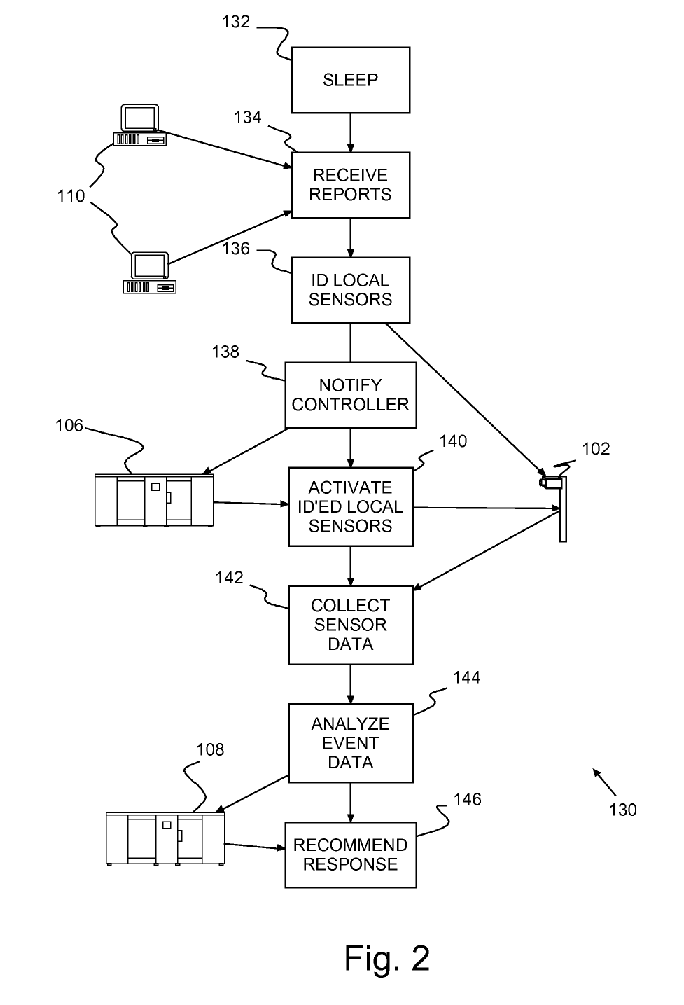

FIG. 2 shows an example of selectively monitoring 130 activity in an area, e.g., area 104 in FIG. 1 with like features labeled identically. Initially, at least a subset of surveillance sensors 102 are inactive, or in a sleep mode 132, not capturing data, to conserve energy, storage space and to insure local privacy. As reports (R) begin to arrive 134 at the event monitor 108, the event monitor 108 identifies 136 a subset (D) of sensors 102 in the vicinity of the reported incident and notifies 138 the sensor controller 106. Preferably, the event monitor 108 also recommends resources for responding to the incident. The sensor controller 106 activates 140 identified local sensors 102 and forwards the sensor data to the event monitor 108, which begins collecting information 142 about the ongoing incident. The event monitor 108 analyzes 144 the collected information and may recommend 146 a response, e.g., from a table or list of previously determined potential responses.

So, the surveillance sensors 102 remain inactive until one or more users send 134 reports reporting an area event taking place in a the geographical area (city), e.g., by email, as a text message or chat, or through the reporting application. The event monitor 108 may correlate reports to single out reports R for a single event, and identify 136 a set D of local sensors, e.g., security cameras, that are closest to the event location. Then, the event monitor 108 notifies 138 the sensor controller 106, which sends 140 activation signals to activate the D local sensors with the balance of the sensors remaining in sleep mode until otherwise awakened. The event monitor 108 also may estimate an expected total volume of information collected, e.g., video/image data information for the event and generates a report recommending adequate or necessary resources to process the expected total data, e.g., a number of additional operators or security personnel and processing resources required to process the data. The activated D local sensors collect 142 media content data (e.g., still or video images) until the event ends or for a given period of time, e.g., 5 minutes. The sensor controller 106 returns the data to the event monitor 108, which analyzes 142 the collected information.

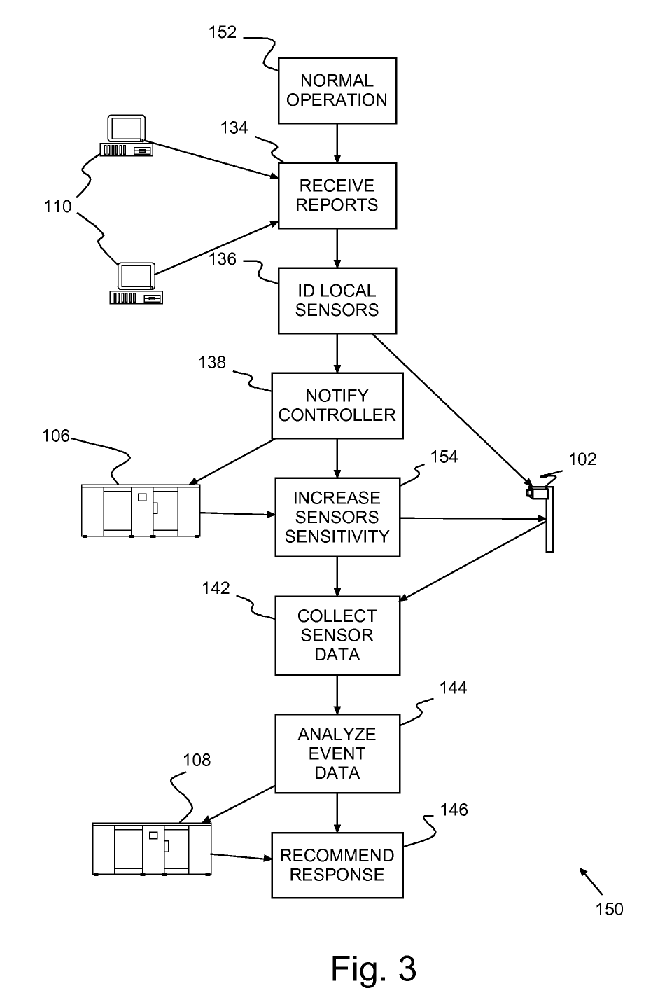

FIG. 3 shows an alternate example of monitoring 150, substantially similar to the example of FIG. 2 with like steps labeled identically. In this example, however, all sensors 102 remain active, continually providing low level surveillance, and reporting 152 normal area activity to the event monitor 108. As reports begin to arrive 134 at the event monitor 108, the event monitor 108 identifies 136 local sensors 102 in the vicinity of the reported incident and notifies 138 the sensor controller 106. The sensor controller 106 increases interrogation 154 of information from identified local sensors 102 and begins collecting information 142 about the ongoing incident. The event monitor 108 analyzes 144 the collected information and may recommend 146 a response.

Sensors 102, such as video cameras, distributed at multiple area locations may be panned out normally for a wide view of the surveillance area, capturing and caching media content at a low resolution, low frame rate, e.g., one frame per second (lfps). Although described in this example in terms of video cameras monitoring an area such as a city, it is understood that the sensors 102 may be any suitable surveillance sensor, e.g., audio, IR, noise and/or pressure sensors, and the area may be any monitored area, including more restricted environments, such as company sites or company buildings. The sensors 102 send data, low resolution, low frame rate video of this example to the event monitor 108, which stores the data 152 normally and assigns standard/normal verification priority to each frame.

Once users begin sending 134 reports R through the reporting application that are related to a locally occurring event, the event monitor 108 identifies 136 the set D cameras that are closest to the event location. The event monitor 108 notifies 138 the sensor controller 106, which increases the data collection priority for the M most local sensors 102. In this example, the sensor controller 106 re-aims those M local cameras towards the event, refocuses, and increases frame rate and resolution. Upon receiving 142 enhanced data the event monitor 108 analyzes 142 the media content captured according to assigned priorities.

Advantageously, the present invention provides a self-rousing surveillance system, capable of collecting data from a geographical area, such as a city, blanketed with surveillance sensors. The preferred self-rousing surveillance system may normally collect minimal data from an area blanketed with surveillance sensors that is sufficient for security personnel to monitor normally. If and when an event occurs within the geographical area, the preferred self-rousing surveillance system focusses attention to the event in real time, caching pertinent data.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A self-rousing surveillance system comprising:
a plurality of surveillance sensors distributed about a geographical location;
a sensor controller controlling data collection by each of said plurality of surveillance sensors, said sensor controller maintaining said plurality of surveillance sensors normally in a low surveillance state; and
an event monitor receiving reports indicating events at local areas within said geographical location, said event monitor identifying said local areas to said sensor controller, said sensor controller placing ones of said plurality of surveillance sensors identified with each local area in a heightened surveillance state responsive to received said reports.

2. A self-rousing surveillance system as in claim 1, wherein in said low surveillance state said ones are in a sleep state, and said sensor controller activates said ones from said sleep state to place said ones in said heightened surveillance state.

3. A self-rousing surveillance system as in claim 1, wherein in said low surveillance state said ones are in a normal surveillance operation state, and in said heightened surveillance state said sensor controller increases surveillance capture from said ones.

4. A self-rousing surveillance system as in claim 3, wherein in said heightened surveillance state said sensor controller selectively increases surveillance capture from said ones.

5. A self-rousing surveillance system as in claim 4, wherein increasing surveillance capture is selected from one or more of increasing data capture frequency, increasing capture resolution and directing capture focus.

6. A self-rousing surveillance system as in claim 1, wherein said plurality of surveillance sensors comprises at least one image capturing device, at least one audio capture device, and at least one motion sensor.

7. A self-rousing surveillance system as in claim 1, wherein said plurality of surveillance sensors comprises citizen sensing platform stations at one or more of said local areas, event reports being sent to said event monitor from said citizen sensing platform stations.

8. A self-rousing surveillance system as in claim 7, wherein said citizen sensing platform stations are at one or more kiosks in respective said local areas and one or more local computers running a citizen sensing platform application.

9. A self-rousing surveillance system as in claim 7, wherein said citizen sensing platform stations comprise portable devices running a citizen sensing platform app.

10. A self-rousing surveillance system as in claim 1, wherein said sensor controller is on a first computer and said event monitor is on a second computer.

11. A method of monitoring activity across a geographical location, said method comprising:
placing a plurality of surveillance sensors in a low surveillance state, said plurality of surveillance sensors being distributed about a geographical location;
receiving one or more event reports reporting an event at a local area within said geographical location;
identifying ones of said plurality of surveillance sensors identified with said local area;
placing said identified ones in a heightened surveillance state responsive to received said reports; and
collecting and analyzing data from said identified ones; and
notifying an authority responsible for securing said reported event.

12. A method as in claim 11, wherein placing said identified ones in said heightened surveillance state comprises selectively increasing surveillance capture from selected said ones.

13. A method as in claim 12, wherein said low surveillance state is sleep mode, and notifying said authority comprises routing said event report to a corresponding processing location.

14. A method as in claim 12, wherein in said low surveillance state comprises collecting location activity data at a first capture rate, and placing said identified ones in said heightened surveillance state comprises increasing surveillance capture from selected said ones.

15. A method as in claim 14, wherein increasing surveillance capture comprises selectively increasing data capture frequency, increasing capture resolution and directing capture focus.

16. A method as in claim 15, wherein increasing data capture frequency comprises increasing video recording frame rate, increasing capture resolution comprises increasing video recording resolution, and directing capture focus comprises redirecting one or more video cameras to a different location and re-focusing said one or more video cameras to said different location.

17. A method as in claim 14, wherein increasing surveillance capture comprises giving priority to sensor information being collected from said ones.

18. A method as in claim 11, further comprising:
entering said event reports at citizen sensing platform stations at one or more of said local areas, said citizen sensing platform stations being at one or more kiosks in respective said local areas, in one or more local computers running a citizen sensing platform application, and one or more portable devices running a citizen sensing platform app; and
providing a recommended response for said event.

19. A computer program product for monitoring activity across a geographical location, said computer program product comprising a non-transitory computer usable medium having computer readable program code stored thereon, said computer readable program code comprising:
computer readable program code for receiving reports indicating events at local areas within a geographical location;
computer readable program code for identifying said local areas with indicated events and one or more local surveillance sensors in each local area;
computer readable program code for placing said one or more local surveillance sensors in a low surveillance state, and selectively placing said one or more local surveillance sensors in a heightened surveillance state responsive to received said reports; and
computer readable program code for collecting and analyzing data from said one or more local surveillance sensors.

20. A computer program product as in claim 19, wherein in said low surveillance state said ones are in a sleep state, and in said heightened surveillance state said sensor controller activates selected said ones from said sleep state.

21. A computer program product as in claim 19, further comprising:
computer readable program code for citizen sensing platform stations for providing said event reports from said local areas to said computer readable program code for receiving reports; and
computer readable program code for recommending a response for said event.

22. A computer program product as in claim 19, wherein said computer readable program code for collecting and analyzing data comprises computer readable program code for image analysis, and voice analysis, and said computer readable program code for placing said one or more local surveillance sensors comprises computer readable program code for increasing video recording frame rate, increasing video recording resolution, redirecting one or more video cameras to a different location and re-focusing said one or more video cameras to said different location.

23. A computer program product for monitoring activity across a geographical location, said computer program product comprising a non-transitory computer usable medium having computer readable program code stored thereon, said computer readable program code causing one or more computers executing said code to:
place surveillance sensors distributed about a geographical location in a low surveillance state;
receive event reports reporting an event at a local area within said geographical location;
identify a plurality of surveillance sensors identified with said local area;
place said identified ones in a heightened surveillance state;
collect and analyze data from said identified ones; and
notify an authority responsible for securing said reported event.

24. A computer program product for monitoring activity across a geographical location as in claim 23, said wherein computer readable program code placing said identified ones in said heightened surveillance state causes said one or more computers executing said code to:
increase video recording frame rate;
increase video capture recording resolution;
redirect one or more video cameras to a different location; and
re-focus said one or more video cameras to said different location.

25. A computer program product for monitoring activity across a geographical location as in claim 23, said computer readable program code further causing said one or more computers executing said code to accept said event reports at citizen sensing platform stations at one or more of said local areas; and
wherein computer readable program code placing said identified ones in said heightened surveillance state causes said one or more computers executing said code to give priority to sensor information being collected from said ones.
